(19) United States
(12) Patent Application Publication
(10) Pub. No.: US 2025/0259187 A1
(43) Pub. Date: Aug. 14, 2025

(54) METHOD FOR AUTHENTICATING A HIGH-VALUE ITEM

(71) Applicant: Wolfgang SEIB, Schopfloch (DE)

(72) Inventor: Wolfgang SEIB, Schopfloch (DE)

(21) Appl. No.: 19/194,517

(22) Filed: Apr. 30, 2025

Related U.S. Application Data
(63) Continuation-in-part of application No. 18/291,885, filed on Jan. 24, 2024, now Pat. No. 12,314,810.

(30) Foreign Application Priority Data
Jul. 27, 2021 (DE) 202021002500.6

(51) Int. Cl. G06Q 30/018; G06K 19/06

(52) U.S. Cl. CPC G06Q 30/0185; G06K 19/06037; G06K 19/06046

(57) ABSTRACT

A method for authenticating a high-value item, wherein an optically identifiable code is generated and applied to the item by being integrated into a surface region of the item that is provided with graphics or a surface structure, wherein the code is read and interpreted using a reader, wherein the code is generated in the form of a two-dimensional arrangement comprising at least one of one or multiple dots, dash elements, line elements, the code elements having a shape comprising one of one or more multiple dots, dash elements, line elements forming part of the motif of the item, and wherein the code has information content decodable by a reader and is linked to an information source that provides information related to the item, and when the code is read by the reader, the link to the information source is activated and the information is displayed on the reader.

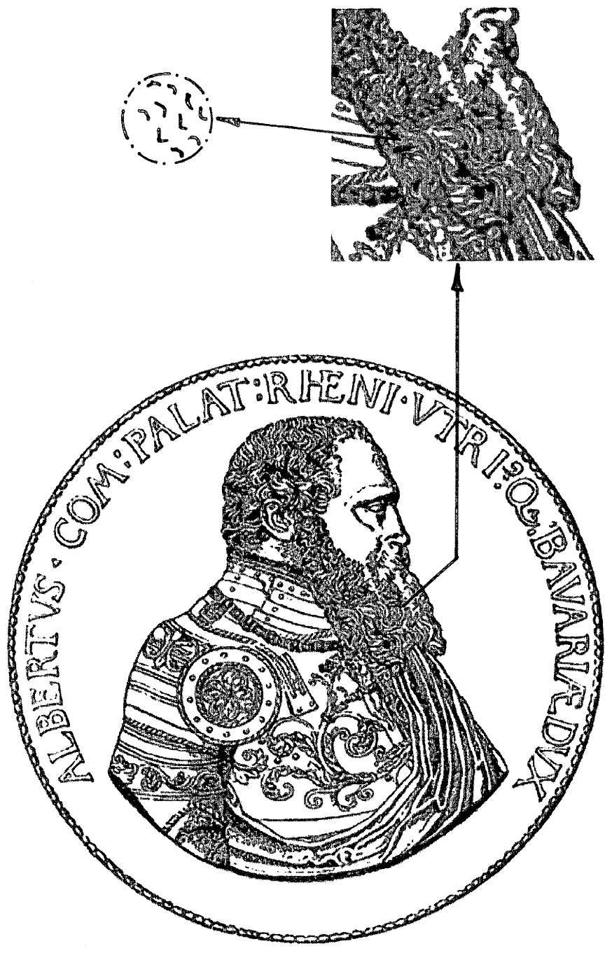

### CROSS-REFERENCES TO RELATED APPLICATIONS

The present application is a continuation in part based on U.S. application Ser. No. 18/291,885, filed Jan. 24, 2024, which is based on PCT Application No. PCT/DE2022/000083, filed Jul. 26, 2022, which claims priority and benefit from German Patent Application No. 20 2021 002 500.6, filed on Jul. 27, 2021.

### BACKGROUND OF THE INVENTION

The invention relates to a method for authenticating, e.g., verifying the authenticity of, a high-value item such as a coin or medal, a precious-metal bar, a piece of jewelry or an art object, an expensive watch or the like, by which method an optically identifiable code is generated and applied to the item, from where it can be read and interpreted.

Valuable items such as coins, medals, precious-metal bars and other valuable items such as art objects depend, in terms of their value, largely on the question of authenticity. It is common practice to issue certificates to confirm the authenticity of such items. Such certificates of authenticity have the disadvantage of not being connected to the item itself, so that the problem of authenticity shifts to the question of whether the item is actually the certified item, because there is no connection between the certificate and the item, but then the problem also involves the question of whether the certificate itself may have been counterfeit.

Providing the item itself with an appropriate marking is of little help because, on the one hand, it is undesirable to apply a visible marking to the item itself, as it might deface the item, but even if the marking is invisible to the eye and can only be seen under UV light, for example, it does not provide safe protection against counterfeiting, since common markings, if recognizable by counterfeiters, can also be easily copied by counterfeiters. Therefore, marking such items with coded information in the form of conventional barcodes, QR codes or the like is not suitable way to provide counterfeit-proof marking. Such markings would always be recognized as code, which means they can also be read and copied as code, even if the information content is unrecognizable.

However, apart from the need for authenticity marking of valuable items, there may also be a need to provide an item of material or non-material value with information about the item, such as its origin, age, or designer or artist. This may be the case in particular with items in collection systems such as albums or cassettes, where providing a detailed description of the item in the collection system itself is difficult and usually disruptive. In this case, too, it would be useful and desirable to provide the item itself with a marking that allows such information to be made visible without interfering with the item itself, and that is virtually invisible.

Conventional security features such as holograms, which are mainly used on banknotes, are also not useful for the purpose described, as they are also easily visible and can be copied.

Consequently, the object of the invention is to provide a method for authenticating valuable or high-value items, which overcomes the problems of conventional measures.

### BRIEF SUMMARY OF THE INVENTION

According to the invention, this object is achieved by the method specified in claim 1, which is further developed by the features of the dependent claims.

In the inventive method, the items are provided with a permanent, quasi-invisible marking in the form of a special code that protects the item against counterfeiting and can serve, in particular, as a hidden and invisible or visually imperceptible security feature. The code can be read with a suitable reader such as a smartphone that includes a special app, with the content of the code itself being unrecognizable to the user, but, for example, the code serving as a link that redirects the user to a website. The app may be freely available to the user and be downloaded to the smartphone from an app store, for example.

The code consists of a two-dimensional pattern of tiny elements, which may be line elements that can have different shapes and orientations, i.e., may be straight, curved, or bent at different angles. Small area elements such as dots or the like may also form part of the two-dimensional pattern.

In one embodiment, the tiny elements, which may be line elements, may be arranged to supplement, continue or replace existing lines of a motif of the item. In particular, the tiny elements, which may be line elements, may supplement, continue or replace at least a part of an outline of such a motif, which may be in the form a surface structure. In an embodiment, there may be multiple parts of outlines of the item's motif that the tiny elements, which may be line elements, supplement, continue or replace.

The elements of the code may be distributed across surface regions of the items to be marked, which are covered by a motif, such as an image pattern, a graphic pattern such as a decoration or lettering, or which are not smooth in some other way, the surface patterns being flat (e.g., printed) or relief-like (such as engravings).

Unlike a QR code, the two-dimensional pattern preferably does not have a pre-defined outline; rather, the outline may be arbitrary, and, in particular, may be adapted to the shape of the respective surface region or of a part of it. In particular, it may be adapted to a motif of the item, the shape of an outline of the surface region or of a part thereof. Thus, for example, the shape of the two-dimensional pattern of the code may be an elongate, curved or angular, potato-shaped or other irregular outline, an outline of a motif of the items, or parts thereof.

For example, a line clement may replace an outline or part of an outline of a motif, such as, for example, an image or a surface structure of the item, wherein the line element may have a form or shape similar or substantially equal to a corresponding line or outline of the motif, however, moved by a slight amount (and the original line or outline of the motif may be removed from the motif) to effectively replace the respective outline of the motif or parts thereof of the unmodified motif at a position that deviates only minimally from its position in the unmodified motif. Such a minimally modified motif will include the code elements, which may be line elements, in a hidden, invisible or visually imperceptible way for a viewer.

The invention makes use of the fact that high-value items in general, and in particular those of the above type, are virtually always provided with a motif, such as, graphics, a picture or decorative elements in at least one surface region or, as is regularly the case with art objects, have at least one non-smooth bottom surface or, for example in the case of paintings, a non-smooth reverse side, where a marking according to the invention can be placed to be concealed within the pictorial representation and not perceivable by the viewer.

Therefore, the viewer cannot perceive that, or whether, the item has been provided with code elements as outlined above, which, for example, replace outlines of the motif or parts thereof of the unmodified motif at a position that deviates only minimally from its position in the unmodified motif.

The marking according to the inventive method is different from conventional marking not only in that a viewer of the item cannot recognize it even on close inspection, or in fact tell whether it exists at all, but also in that it can be applied to different items in a relatively connected or unconnected manner and may be adapted to fit various geometries, e.g., in different regions of a graphic or an image representation on the item, possibly divided, and adapted to the outline of the respective motif, graphic or image.

In contrast to a conventional barcode or QR code, in which the individual code elements are geometrically related to each other in a predetermined and unchangeable way to be readable, the markings according to the invention are composed of one or more individual unconnected line elements that can be geometrically arranged so as to slightly modify the motif of the item by slightly moving, for example, section of outline contours or other line item elements of the motif of the item. Thus, the marking according to the invention is adapted to the respective motif which makes it even harder to recognize.

In the case of watches, for example, the dial usually includes numbers, lines, graphics, or text. The arrangement of line elements may be applied almost invisibly to these distinct motif elements, for example, by minimally modifying the outlines of the text or numbers.

In one embodiment, the arrangement of the elements of the code may in fact replace the outlines or at least a part of the outlines of the motif of the item, such as, an image or surface structure. In this case, a shape of the modified line elements may correspond to or resemble a shape of the original outlines or of the parts of the original outlines, wherein the line elements are arranged slightly offset relative to the original outlines or the parts of the original outlines. This renders the marking barely visible to the human eye, but still detectable with a suitable reader such as a smartphone that includes a special app for analyzing the so-modified motif, such as an image. As indicated above, the marking according to the inventive method can be divided into several areas. For example, one part may be located in an upper right-hand corner and another part in a lower left-hand corner of a motif of the item, such as an image or a graphic. It may also be divided into two or three busier or darker regions of a graphic, where it stands out particularly poorly from the background. Or the marking may extend over part of, or all of, a circular ring area or another band of area, or may be integrated into lettering.

Even a completely smooth item, such as a precious-metal bar that is smooth on all sides, the value of which depends on its material, not its surface properties, may be provided with such a marking as a security feature by applying to a surface portion a decorative graphic that can be arbitrarily selected to conceal the marking in it. In the case of precious-metal bars, for example, the indication of value or purity, usually applied together with an indication of origin, is sufficient for embedding the marking according to the invention. The smooth surface of a precious-metal bar, for example, may also be provided with a decorative line pattern, such as a wavy pattern, in which at least some the lines are, for example, minimally offset relative to a perfectly regular wave structure. None of this is possible with the design of a bar code or QR code.

The marking may be applied to the item in any suitable way, e.g., by printing, engraving or lasering. However, the marking may also be applied by embossing, stamping, punching or casting, by including the code elements in the respective tool as an integral part of the surface pattern to be produced, i.e., the respective embossing tool, punching tool or casting mold. This can be easily done because nearly all tools today are manufactured on CNC machines.

The method according to the invention further comprises providing a reader for reading the code, and the process of reading with the reader, which is appropriately programmed to be able to recognize and capture the code. The reader is preferably a smartphone with a special app installed on it containing the program for recognizing and reading the code. As mentioned above, this app may be freely available and may be downloaded by the user onto their smartphone.

The code itself may encode a destination address and thus embody a link that is activated when the code is read and used to call an associated information source in the form of, for ex-ample, a website and/or an API, which then served to present to the user visible information on the display, e.g., information about the item in question, which indicates its essential characteristics and confirming its genuineness or authenticity, and which may also indicate further information about the item in question, such as its origin, number, time of manufacture, purity or other properties of the item.

Another advantageous use of the marking according to the inventive method is that it makes the respective item traceable in terms of its origin, e.g., to verify compliance with supply chains. The marking according to the invention is not only relevant as a security feature, but may also serve as a digital certificate.

The method according to the invention, the general features of which have been described above, will be presented in more detail below, with its function and implementation described more closely.

The function and implementation of the process is relatively simple. First, the destination address or the data and information to be assigned to the product are determined. In particular, it is possible to apply to the product a non-visible code as described above. The code may encode only a numerical code or text. However, it is also possible to integrate on the product information about the product, or a graphic etc., which may then be decoded and displayed directly on the reader.

The user can be directed, via the code, to a URL, such as a website address or an API, which may be a store, a landing page, or any other kind of network connection and/or address. The link may also be dynamic, i.e., may lead to a respective target address via redirects that may optionally be substituted or changed.

The invention provides the ideal hybrid solution, i.e., a physical item invisibly connected to the digital and virtual world of the internet, without changing the product's shape, properties, or appearance in general.

It is also possible to implement a security query by linking the product to a website, domain address etc. Thus, there can be one-off access after the first input of the link, with third parties no longer given access thereafter. In this way, security of ownership can be achieved, especially for expensive and rare or limited products of high value.

The encoded link address etc. is broken down and converted into small dots, dash elements, line elements, curved or straight and of regular or irregular form, and/or small area elements. The choice of dashes, dots, lines, etc. to use in which amount and distribution, as well as their arrangement and size, depends on the respective motif of the item, i.e., the surface structure, graphic or image etc. This is the only way to achieve almost invisible integration of the marking of the invention into the motif of the item, namely by using essentially parts of the elements of the motif, for example, a contour outline or other graphical elements included in the motif, and only slightly modify these existing elements, for example, by slightly moving at least parts of them out of their position. This re-positioning the encode information that, in its entirety, that is, by combining multiple such modifications of the motif of the items, produces the link information encoded in the marking.

To modify the motif of the item, its existing motif, such as, a graphic or image etc., can be enlarged to previously defined dimensions in the exact ratio. The modifications to the motif of the item by using the dots, dashes, lines, curved or straight and of regular or irregular form, etc. as outlined above can now be embedded into the motif to build the code in the motif, such as, the image or surface structure of the item using the previously precisely defined enlargement.

It can then be checked whether the dashes, lines, dots etc. integrated as code into the surface pattern of the item have changed the motif, image or the graphic or surface structure of the item in an undesirable way. It may be necessary to make further adjustments and changes to achieve an optimal result. A perfect result has been achieved when the inserted dots, dashes, lines, curved or straight and of regular or irregular form, etc. are almost imperceptible in the enlarged image and have a smooth transition to the background image or surface structure.

Given the marking of the invention is not embedded in the empty spaces of the motif, but applied directly to visible elements of the motif, such as, surface pattern or image patterns it is very difficult to discern what belongs to the regular motif of the item, such as, an image pattern, graphic pattern or other surface pattern, and what belongs to the code.

In one embodiment, the applied dots, dashes, lines, curved or straight and of regular or irregular form, of the marking of the invention may replace original dots, dashes, lines, curved or straight and of regular or irregular form, of the motif, such as, the visible surface pattern or image pattern of the item. Replacing means that any originally provided structure or element, i.e. a dot, a dash, a line, curved or straight and of regular or irregular form, and/or an outline, etc. is removed from the original motif, such as an image or a surface structure element, while a corresponding element (such as, a dot, a dash, a line, curved or straight and of regular or irregular form, and/or an outline, etc.) which forms a part of the code element of the invention, is applied in the general vicinity, and possibly only very slightly offset from the original element.

What is only slightly visible in a very enlarged state then becomes even less visible when subsequently scaled back to the desired original size; it is therefore a quasi-invisible code.

The code can be integrated into any type of tool, such as punching tools, injection molding tools, deep-drawing tools, pressing and embossing tools, as well as for all types of molds, e.g., in printing plates etc. This makes it possible, for example, to automatically integrate the code as early as during manufacture of series products such as coins and medals, metal bars, watches, writing utensils, household items, cosmetics, jewelry, etc. For example, the invisible code may already be integrated into the embossing tool, punching tool or casting tool for manufacturing coins, medals or metal bars. As a result, for example, each metal bar or coin manufactured or any product or article will automatically receive an invisible identification code.

Depending on the security requirements, visual presentation, recognizability, etc., the code may be applied to any place on the product having a motif. It is also possible to integrate several partial codes in different places of the motif(s) of the product, so that a single valid code is only created by combining all partial codes in one or several scanning processes.

Three-dimensional integration of the code (surface, relief, and transition on the sides) creates even more flexibility and security. This can be a two-dimensional code on a surface, joined by an additional code on a side. A further development of the method according to the invention is a measure for copy protection of the code applied according to the method.

For this purpose, the product provided with the code, or its surface area containing the code, may have applied to it a coating that is imperceptible to the human eye and has extremely light-reflecting particles dispersed in it; the coating may be a special paint in which extremely reflective beads in the micro range are distributed.

By optimally adjusting the size, geometry, number and color of such microbeads, they can be perfectly adapted to the respective surface graphic or surface structure. This also allows the intensity of the glare effect produced by the beads to be optimally adjusted.

If an attempt is made to copy the image on a photocopier, the image becomes white and blurry due to the glare effect when being illuminated by the photocopier during scanning, so that nothing is recognizable.

### BRIEF DESCRIPTION OF THE DRAWINGS

The attached FIGURE schematically depicts a coin (bottom) as well as a first magnification of a section of the coin image (top right) and a second magnification of the first magnification (top left).

### DETAILED DESCRIPTION OF THE INVENTION

The attached drawing shows, as an exemplary item, a coin or medal with a motif in the form of a coin image comprising a legend and a pictorial representation of the upper body of a man in armor. A section of the beard region of the head depicted in the coin image has been enlarged to the top right, which is also an example of a region of the coin image that is confusing due to a tangle or a multitude of lines. This region is particularly suitable for placing a code according to the above-described method in the form of a two-dimensional arrangement of individual line elements; the outline of the arrangement may be adapted to the outline of the beard region.

The arrangement of line or dash elements as a whole forms a code which can be assigned a selectable meaning. The line elements can be characterized by shorter or longer, straight or curved dash portions, which may be the same or similar from each other and the lines of the original motif, and which may be arranged in the same orientation or different orientations.

The individual line elements are applied to the coin or medal in such a way that they are at least largely invisible to the human eye, even if they have been physically produced by embossing, because the elements forming the code appear to the viewer as part of the coin image and the viewer therefore cannot realize that there is a marking, let alone differentiate between image and code. However, reading is possible with a reader such as the camera of a smartphone equipped with a special app that can recognize the arrangement of the line elements as a code.

In the same way, for example, the hair region of the coin image, the outline of the head, eye portions of the displayed head, or some other region of the coin image, would be suitable for accommodating the code elements.

Specifically, as shown in the attached drawing, a line element representing a code or at least a part of a code may replace a line or outline of the original coin image (i.e. the motif). The shape of the line element can be similar or even equal to the shape of the line or outline, which is replaced by the line element.

As shown in the attached drawing, the outline of the beard region of the head depicted in the coin image is replaced by a line element. The shape of the line element corresponds to the shape of the original outline that is replaced but is applied to the motif marginally offset with respect to the original outline of the beard region of the head depicted in the coin image. An extent of the offset may form a part to the information content of the code.

This modification of the original coin image is practically invisible to a viewer, but still detect-able by a reader such as the camera of a smartphone equipped with a special app that can recognize the arrangement of the line elements as code or as part of a code.

What is claimed is:

1. A method for authenticating a item, the method comprising:
generating and applying to the item an optically identifiable code; and
reading and interpreting said code using a reader, wherein:
a surface region of the item provided with a motif, such as, a graphic or a surface structure, or a part of said surface region, is selected,
a code is generated in a form of a two-dimensional arrangement of one or multiple code elements comprising at least one of one or multiple dots, dash elements, line elements, the code elements having a shape comprising at least one of one or multiple dots, dash elements, line elements forming part of the motif of the item, and being arranged offset relative thereto, and
the code elements having an information content decodable by a reader provided with programming for recognizing and reading the code,
the code linking to an information source providing information displayable on a display of the reader, in relation to the item, when decoded and
when the code is read and decoded, the link to the information source is activated and the information displayed on the display of the reader.

2. The method according to claim 1, wherein the code elements are straight, curved, or bent at different angles, and/or having a regular or irregular form.

3. The method according to claim 1, wherein the code is integrated in a form of two or more partial codes, each having a form of a two-dimensional arrangement of one or more code elements, on two or more spaced-apart parts of a surface region or on different spaced-apart surface regions of the item, the two or more partial codes being captured together when being read.

4. The method according to claim 1, wherein the shape of at least one of the code elements, corresponds to a shape of a dot, dash element or line element forming part of the motif of the item.

5. The method according to claim 1, wherein at least one of the code elements replaces a corresponding dot, dash element or line element forming part of the motif of the item.

6. The method according to claim 1, wherein the code is applied to the item by printing, engraving or laser engraving.

7. The method according to claim 1, wherein the code is integrated into a working surface region of a pressing tool, punching tool, embossing tool, casting mold or other tool, which working surface region is used for producing a surface structure of the item, so as to produce the surface structure provided with the code during manufacture of the item.

8. The method according to claim 1, wherein the code, when decoded, links to the information source indirectly via at least one intermediate location through which a connection to the information source can be manipulated.

9. The method according to claim 1, wherein at least the surface region of the item provided with the code is coated, after integrating the code, with a coating that has extremely light-reflecting microparticles dispersed in it.
